(19) United States
(12) Patent Application Publication
(10) Pub. No.: US 2026/0362480 A1
(43) Pub. Date: Nov. 12, 2026

(54) COORDINATED BEAM FORMING FRAME FORMATS

(71) Applicant: QUALCOMM Incorporated, San Diego, CA (US)

(72) Inventors: Sherief HELWA, San Diego, CA (US); George CHERIAN, San Diego, CA (US); Alfred ASTERJADHI, San Diego, CA (US); Abhishek Pramod PATIL, San Diego, CA (US); Gaurang NAIK, San Diego, CA (US); Sameer VERMANI, San Diego, CA (US); Jialing Li CHEN, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 19/199,601

(22) Filed: May 6, 2025

(51) Int. Cl. H04W 74/08; H04W 84/12

(52) U.S. Cl. CPC H04W 74/08; H04W 84/12

(57) ABSTRACT

This disclosure provides methods, components, devices and systems for coordinated beam forming frame formats. For example, an access point (AP) may transmit, a coordinated beamforming (CoBF) sounding invite message that includes one or more first user information fields for a second AP. The AP may receive, a CoBF sounding response message that includes a first per-association identifier (AID) traffic identifier (TID) information field. The AP may perform the CoBF sounding procedure. The AP may transmit a CoBF transmission invite message that comprises one or more second user information fields for the second AP that include CoBF operation-related information and information for one or more stations (STAs). The AP may receive a CoBF transmission response message that comprises at least a second per-AID TID information field.

### TECHNICAL FIELD

This disclosure relates generally to wireless communication and, more specifically, to coordinated beam forming frame formats.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point (AP). The method may include transmitting, in association with a coordinated beamforming (CoBF) sounding procedure, a CoBF sounding invite message that includes one or more first user information fields for a second AP, receiving, based on the CoBF sounding invite message, a CoBF sounding response message that includes a first per-association identifier (AID) traffic identifier (TID) information field, performing, based on the CoBF sounding invite message and the CoBF sounding response message, the CoBF sounding procedure, transmitting, in association with a CoBF transmission procedure, a CoBF transmission invite message that includes one or more second user information fields for the second AP, the one or more second user information fields including CoBF operation-related information and information for one or more stations (STAs) associated with the first AP, and receiving, based on the CoBF transmission invite message, a CoBF transmission response message that includes at least a second per-AID TID information field.

Another innovative aspect of the subject matter described in this disclosure can be implemented in a first AP for wireless communications. The first AP may include a processing system that includes processor circuitry and memory circuitry that stores code. The processing system may be configured to cause the first AP to transmit, in association with a coordinated beamforming (CoBF) sounding procedure, a CoBF sounding invite message that includes one or more first user information fields for a second AP, receive, based on the CoBF sounding invite message, a CoBF sounding response message that includes a first per-association identifier (AID) traffic identifier (TID) information field, perform, based on the CoBF sounding invite message and the CoBF sounding response message, the CoBF sounding procedure, transmit, in association with a CoBF transmission procedure, a CoBF transmission invite message that includes one or more second user information fields for the second AP, the one or more second user information fields including CoBF operation-related information and information for one or more stations (STAs) associated with the first AP, and receive, based on the CoBF transmission invite message, a CoBF transmission response message that includes at least a second per-AID TID information field.

Another innovative aspect of the subject matter described in this disclosure can be implemented in another first AP for wireless communications. The first AP may include means for transmitting, in association with a coordinated beamforming (CoBF) sounding procedure, a CoBF sounding invite message that includes one or more first user information fields for a second AP, means for receiving, based on the CoBF sounding invite message, a CoBF sounding response message that includes a first per-association identifier (AID) traffic identifier (TID) information field, means for performing, based on the CoBF sounding invite message and the CoBF sounding response message, the CoBF sounding procedure, means for transmitting, in association with a CoBF transmission procedure, a CoBF transmission invite message that includes one or more second user information fields for the second AP, the one or more second user information fields including CoBF operation-related information and information for one or more stations (STAs) associated with the first AP, and means for receiving, based on the CoBF transmission invite message, a CoBF transmission response message that includes at least a second per-AID TID information field.

Another innovative aspect of the subject matter described in this disclosure can be implemented in a non-transitory computer-readable medium storing code for wireless communications. The code may include instructions executable by one or more processors to transmit, in association with a coordinated beamforming (CoBF) sounding procedure, a CoBF sounding invite message that includes one or more first user information fields for a second AP, receive, based on the CoBF sounding invite message, a CoBF sounding response message that includes a first per-association identifier (AID) traffic identifier (TID) information field, perform, based on the CoBF sounding invite message and the CoBF sounding response message, the CoBF sounding procedure, transmit, in association with a CoBF transmission procedure, a CoBF transmission invite message that includes one or more second user information fields for the second AP, the one or more second user information fields including CoBF operation-related information and information for one or more stations (STAs) associated with the first AP, and receive, based on the CoBF transmission invite message, a CoBF transmission response message that includes at least a second per-AID TID information field.

Some examples of the method, first access points (APs), and non-transitory computer-readable medium described herein may further include operations, features, means, or instructions for initiating the CoBF transmission procedure based at least in part on the CoBF transmission response message.

Some examples of the method, first access points (APs), and non-transitory computer-readable medium described herein may further include operations, features, means, or instructions for transmitting a CoBF trigger/synchronization message that indicates triggering information for the CoBF transmission procedure, at least a portion of the triggering information indicated in one or more third user information fields for the second AP and where the performance of the CoBF transmission procedure may be based on the CoBF trigger message.

Some examples of the method, first access points (APs), and non-transitory computer-readable medium described herein may further include operations, features, means, or instructions for transmitting, to the one or more STAs associated with the first AP and based on the CoBF sounding response message, a sounding initial control frame (ICF) and receiving, from the one or more STAs associated with the first AP and based on the sounding ICF, a sounding initial control response (ICR), where the performance of the CoBF sounding procedure may be further based on the sounding ICR.

Some examples of the method, first access points (APs), and non-transitory computer-readable medium described herein may further include operations, features, means, or instructions for transmitting, to the one or more STAs associated with the first AP and based on the CoBF transmission response message, a transmission initial control frame (ICF) and receiving, from the one or more STAs and based on the transmission ICF, a transmission initial control response (ICR), where the performance of the CoBF transmission procedure may be further based on the transmission ICR.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a coordinated beam forming (CoBF) sounding scheme that supports coordinated beam forming frame formats.

FIG. 3 shows an example of a CoBF sounding frame scheme that supports coordinated beam forming frame formats.

FIG. 4 shows an example of a CoBF transmission scheme that supports coordinated beam forming frame formats.

FIG. 5 shows an example of a CoBF transmission invite frame scheme that supports coordinated beam forming frame formats.

FIG. 6 shows an example of a CoBF transmission invite frame scheme that supports coordinated beam forming frame formats.

FIG. 7 shows an example of a CoBF transmission response frame scheme that supports coordinated beam forming frame formats.

FIG. 8 shows an example of a CoBF sync/trigger frame scheme that supports coordinated beam forming frame formats.

FIG. 9 shows an example of a CoBF sync/trigger frame scheme that supports coordinated beam forming frame formats.

FIG. 10 shows an example of a CoBF sync/trigger frame scheme that supports coordinated beam forming frame formats.

FIG. 11 shows an example of a CoBF CSI scheme that supports coordinated beam forming frame formats.

FIG. 12 shows an example of a process flow that supports coordinated beam forming frame formats.

FIG. 13 shows a block diagram of an example wireless communication device that supports coordinated beam forming frame formats.

FIG. 14 shows a flowchart illustrating an example process performable by or at a first AP that supports coordinated beam forming frame formats.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, access points (APs) (e.g., wireless devices, UEs, network entities) may participate in coordinated beamforming (CoBF), coordinated spatial reuse (C-SR), or both. A CoBF procedure may enable APs to coordinate beamforming based on measurement or sounding from the APs, and transmission between the APs. Such procedures may be divided into at least two phases, including a sounding (e.g., measurement) phase and a transmission phase. Both the sounding phase and the transmission phase may rely on an information exchange between the APs to be performed properly. However, the mechanisms and formats for exchanging such information may not be well defined.

Various aspects relate generally to mechanisms and formats for exchanging sounding and transmission information in the respective phases of CoBF operations. For example, some aspects more specifically relate to a sounding phase of CoBF operations and the frame formats and contents used therein. For example, a sounding invite message transmitted by a first AP may be a buffer status report poll (BSRP) GI3 Trigger or M-BA frame, and may include information associated with the sounding procedure a session ID, initial control frame (ICF)/initial control response (ICR) information, a number of spatial streams (NSS), a channel state information (CSI) confirmation, one or more additional parameters, or any combination thereof. The sounding response message may be an M-BA frame and may also include information associated with the sounding procedure (e.g., feedback type, a CoBF phase indication, an invitation response, a rejection code, NSS information, one or more additional parameters, or any combination thereof).

Some aspects more specifically relate to a transmission phase of CoBF operations and the frame formats and contents used therein. For example, in the transmission phase, a transmission invite message may be a SBRP GI3 trigger frame or M-BA frame and may include information associated with the transmission phase (e.g., feedback type, a CoBF phase indication, an ICF/ICR presence indication, an amount of padding for the transmission response message, one or more additional parameters, or any combination thereof). Further a response to the CoBF transmission response message may indicate information associated with the transmission phase (e.g., a feedback type, a CoBF phase indication, an invitation response, a rejection code, an ICF/ICR presence indication, and ICF/ICR frame exchange duration, one or more additional parameters, or any combination thereof). A CoBF sync or trigger message may include triggering or other information for the transmission operations (e.g., a feedback type, a CoBF phase indication, one or more additional parameters, or any combination thereof). Further, in some examples, an AP may implicitly indicate CSI failure by using a new session ID in a new transmission opportunity (TxOP). Additionally, or alternatively, an AP may terminate a transmission phase in response to a failure to obtain CSI in a sounding phase and may initiate a new sounding phase to rectify the failure to obtain the CSI. Additionally, or alternatively, an AP may solicit a CSI confirmation within a sounding TxOP and may receive a confirmation of CSI obtainment.

Particular aspects of the subject matter described in this disclosure can be implemented to realize one or more of the following potential advantages. In some examples, by including the designated information in the sounding phase messaging, the described techniques can be used to define the sounding phase operations, which allows for collection and analysis of communications conditions, improving the quality of CoBF, allowing for greater communication density, and improved communications throughput and quality. In some examples, by including the designated information in the transmission phase messaging, the described techniques can be used to define the transmission phase operations, which allows for the actual beamforming process to be performed (e.g., based on the collected CSI) allowing for greater communication density and improved communications throughput and quality.

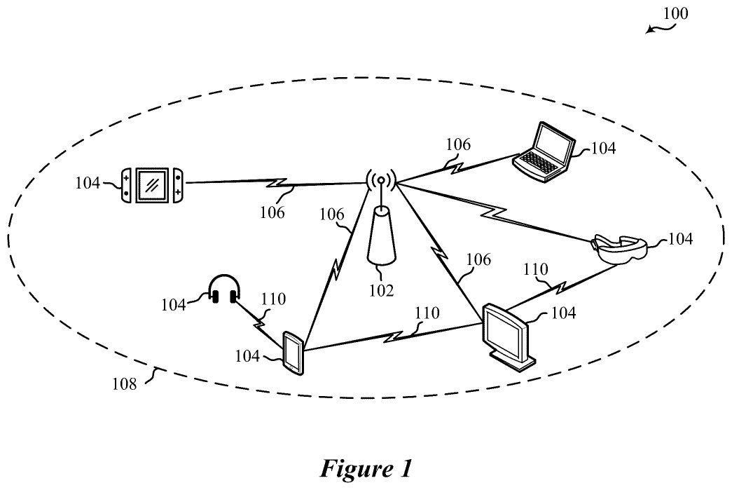

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

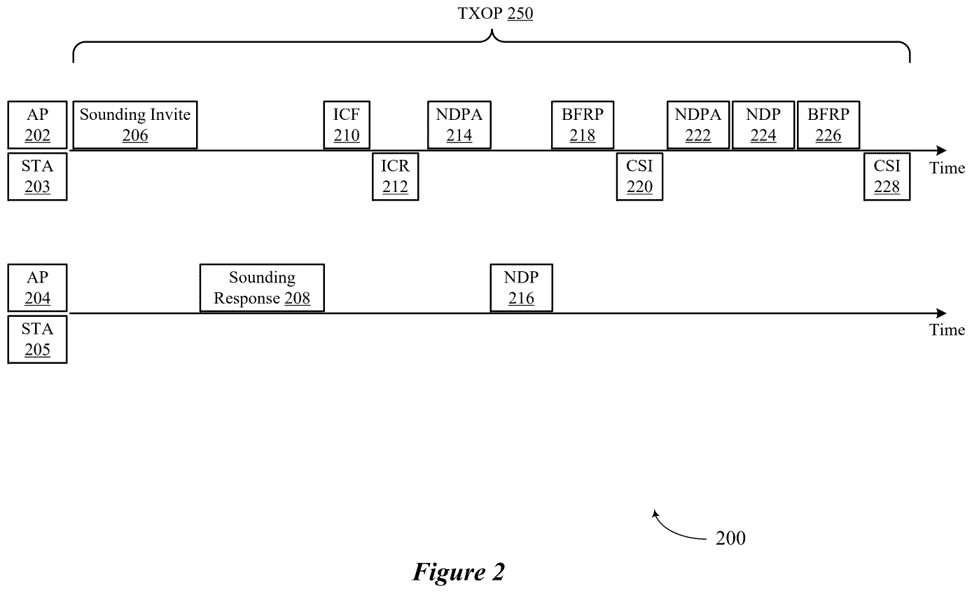

FIG. 2 shows an example of a CoBF sounding scheme 200 that supports coordinated beam forming frame formats. Though only a single TXOP 250 is depicted, it is understood that additional TXOPs may be performed. Further, a subsequent TXOP may involve a mirrored perspective as compared to the TXOP of 250. For example, in the TXOP 250, the AP 204 may collect cross BSS CSI with respect to STA 203, and in an additional TXOP (e.g., a TXOP not depicted), AP 202 may collect cross-BSS CSI with respect to STA 205. Additionally, or alternatively, both instances of cross-BSS CSI collection may be performed in a single TXOP. However, for clarity, only one instance of cross-BSS CSI collection is depicted here.

In some examples, the CoBF sounding scheme 200 may describe operations of the AP 202, the STA 203 associated with the AP 202, the AP 204, the STA 205 associated with the AP 204, or any combination thereof. For example, the CoBF sounding scheme 200 may include a sounding invite 206, a sounding response 208, an initial control frame (ICF), such as the ICF 210, an initial control response (ICR), such as the ICR 212, a null data packet (NDP) announcement (NDPA), such as the NDPA 214, the NDP 216, a beamforming report (BFRP), such as the BFRP 218, the CSI 220, the NDPA 222, the NDP 224, the BFRP 226, and the CSI 228. The NDPA 214, NDP 216, and the BFRP 218 may be involved with cross-BSS measurements, and the NDPA 222, the NDP 224, the BFRP 226, and the CSI 228 may be involved with inter-BSS measurements. Details of portions of the CoBF sounding scheme 200 are described herein.

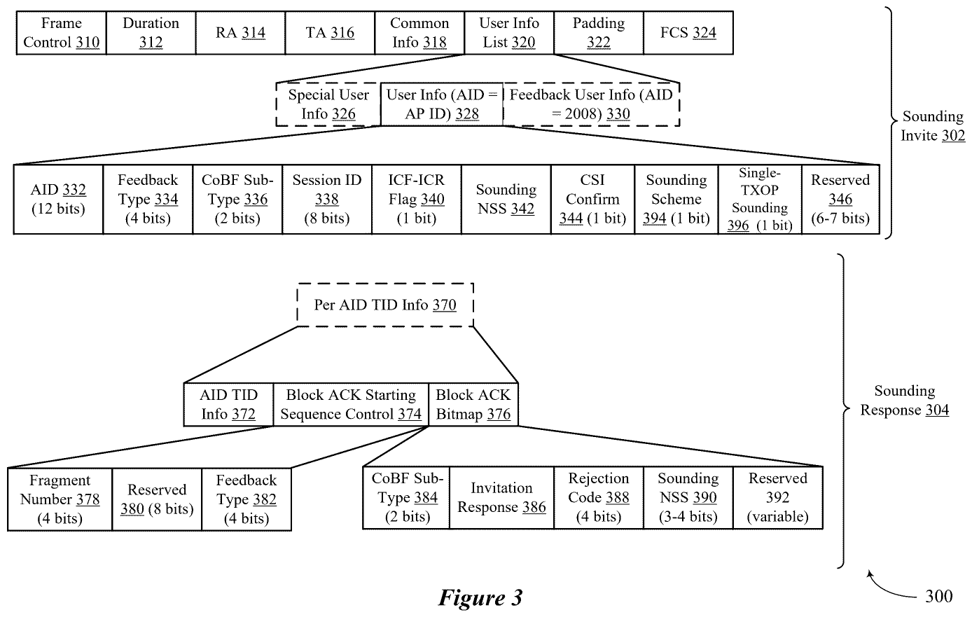

FIG. 3 shows an example of a CoBF sounding frame scheme 300 that supports coordinated beam forming frame formats. The CoBF sounding frame scheme 300 may involve the sounding invite 302 and the sounding response 304, which may be examples of the sounding invite 206 and the sounding response 208. Though some elements or organizations thereof are depicted, any arrangement of any selection of the elements may be employed. For example, though some first elements are depicted as being included in other second elements, the first elements may be included in other elements in different arrangements.

In some examples, the sounding invite 302 may be a buffer status report poll (BSPR) GI3 Tigger frame. The BSRP GI3 trigger frame is a variant of the BSRP trigger frame which solicits a non-trigger-based (non-TB) PPDU in response. In contrast to the normal BSRP GI3 trigger frame, the BSRP GI3 variant may be individually addressed. For example, the sounding invite 302 may be an individually addressed BSRP GI3 frame with the RA field set to the MAC address of the recipient AP (e.g., the AP 204). In the BSRP GI3 trigger frame, the “GI And HE-LTF Type” field value is set to 3 to differentiate it from the normal BSRP trigger frame, hence the naming BSRP GI3.

The sounding invite 302 may include one or more of the frame control 310, the duration 312, the RA 314, the TA 316, the common info 318, the user info list 320, the padding 322, and the frame check sequence (FC) 324. The user info list 320 may include the special user info 326, the user info 328, and the feedback user info 330. The user info 328 may include the association identifier, such as the AID 332, the feedback type 334, the CoBF sub-type 336, the session ID 338, the ICF/ICR flag 340, the sounding number of spatial streams (NSS), such as the sounding NSS 342, the CSI confirm 344, the sounding scheme 394, the single-TXOP sounding 396, and the reserved portion 346.

In some examples, the sounding invite 302 may include an indication of the type of sounding to be initiated (e.g., a joint sounding sequence or a sequential sounding sequence). Further, the sounding invite 302 may include an indication of whether single-TXOP sounding or multi-TXOP sounding is to be used. This means that an AP that is initiating the sounding procedure may indicate to another AP whether the another AP is to initiate the sounding procedure in its BSS in the same TXOP or in a different TXOP.

The sounding invite 302 may be used to communicate sounding-related information in one or more fields, including the user info 328 addressed to the recipient AP and identified by the AP ID assigned during CoBF agreement, one or more feedback user info fields identified by the AID value 2008 indicating control feedback information, a 4-bit feedback type 334 field included in the user info 328, and one or more feedback user info 330 fields to indicate the type of control feedback information included in these fields. In some examples, the user info list 320 may include a special user info 326 field, which may be used to report a physical layer (PHY) version identifier or bandwidth information in the case of 320 MHz BW (e.g., involving a UL BW Extension field).

In some examples, information described herein may be carried in the user info 328. However, in some cases, there may be more information than can be carried in the user info 328. In such cases, some of the information may be carried in a feedback user info 330 field. Description of any information or fields as being included in the user info 328 may, therefore, be considered to also describe inclusion in the feedback user info 330. Further, description of any information or fields as being included in the feedback user info 330 may, therefore, be considered to also describe inclusion in the user info 328.

In some examples, feedback type 334 may indicate the type of feedback included. In some examples, it may be set to a value of 2, to indicate CoBF. In some examples, options may include “2” for CoBF sounding or “3” for CoBF transmission or “4” for CoBF trigger or sync.

In some examples, the CoBF sub-type 336 may be set to a value (e.g., 0 to indicate) to indicate a sub-type of CoBF operation. In some examples, options for the value may include 0 to indicate CoBF sounding operations, 1 to indicate CoBF transmission operations, 2 to indicate CoBF trigger/sync operations, and 3 may be a reserved value. Additionally, or alternatively, a single feedback type value may be used for all multi-AP coordination (MAPC) and a subtype field to indicate the CoBF sounding procedure, the CoBF transmission procedure, or a sync frame within the transmission procedure.

In some examples, the session ID 338 may implicitly indicate the creation of a new CoBF sounding session. In some examples, an existing session ID may indicate continuation of an existing CoBF sounding session. In some examples, an AP that creates the new session ID may occupy a sync-reference role. In some examples, in response to the creation of a new sounding session ID, the old sounding context may be flushed, which, in some examples, may include reassignment of cross-BSS CSI and synchronization roles. In some examples, the session ID 338 may be 8 bits initially to match a dialog token, but may, in some examples, be reduced, such as to 2-3 bits.

In some examples, the ICF/ICR flag 340 may indicate whether the ICF/ICR is to be performed during the sounding procedure. For example, the ICF/ICR flag 340 may be set to 1 when ICF/ICR is included in the sequence and 0 otherwise.

In some examples, the sounding NSS 342 may indicate a quantity of spatial streams to be employed within the current session (e.g., based on the NSS capability of one or more STAs). In some examples, the sounding NSS 342 may indicate a minimum quantity (e.g., of a maximum quantity) of NSS supported across the STAs. In some examples, the NSS may be preserved during in-BSS sounding.

In some examples, the CSI confirm 344 may indicate confirmation of CSI obtainment from a previous sounding TXOP if the session ID 338 is the same as a previous session ID 338. In some examples, a value of 1 may be employed to indicate successful reception and a value of 0 to indicate that the CSI was not received or not available. In some examples, the not available case may occur in situations in which cross-BSS sounding has failed in a previous sounding TXOP.

In some examples, the sounding response 304 may be an M-BA frame that may include a Per AID TID Info 370 field dedicated for CoBF sounding-related info. In some examples, the per-AID TID info 370 field may be included in any portion of the sounding response 304 or at any level of nesting within the elements of the sounding response 304.

In some examples, the sounding scheme 394 may indicate a sounding scheme that is to be used in connection with sounding operations. For example, a sounding scheme may be associated with one or more parameters or values for such parameters that may express or define one or more characteristics of the sounding scheme. In some examples, a value of 0 of the sounding scheme 394 may indicate a first scheme and a value of 1 may indicate a second scheme.

In some examples, the single-TXOP sounding 396 may indicate whether the sounding operations of multiple APs (e.g., the AP 202 and the AP 204) are to be performed within a single TXOP or within multiple TXOPs.

In some examples, the sounding response 304 may include a frame control field, a duration field, an RA field, a TA field, a block ACK (BA) control field, a BA info field, and a (frame check sequence) FCS field. Further, the sounding response 304 may include per-AID traffic identifier (TID) info, such as the per-AID TID info 370. The per-AID TID info 370 may include the AID TID info 372, the block ACK starting sequence control 374, and the block ACK bitmap 376. The block ACK starting sequence control 374 may include the fragment number 378, the reserved 380, and the feedback type 382. The block ACK bitmap 376 may include the CoBF sub-type 384, the invitation response 386, the rejection code 388, the sounding NSS 390, and the reserved portion 392.

In some examples, the feedback type 382 may indicate the type of feedback included. In some examples, it may be set to a value of 2, to indicate CoBF. In some examples, options may include “2” for CoBF sounding, “3” for CoBF transmission, or “4” for CoBF sync.

In some examples, the CoBF sub-type 384 may be set to a value (e.g., 0) to indicate the sounding phase or sounding operations. In some examples, options for the value may include 0 to indicate CoBF sounding operations, 1 to indicate CoBF transmission operations, 2 to indicate CoBF trigger/sync operations, and 3 may be a reserved value. Additionally, or alternatively, a single feedback type value may be used for all multi-AP coordination (MAPC) and a subtype field to indicate the CoBF sounding procedure, the CoBF transmission procedure, or CoBF sync.

In some examples, the invitation response 386 may indicate whether the sounding invite 302 is accepted or rejected. The rejection code 388 may indicate one or more reasons for the rejection, such as unavailability, missing CSI, a quantity of buffered traffic that does not satisfy a buffered traffic threshold, unavailability of one or more STAs, a quantity of STA resources that does not satisfy a resource threshold (e.g., STA's spatial streams or a quantity of available SSs does not satisfy the threshold). In some examples, a value of 1 may indicate acceptance of the sounding invite 302 and 0 otherwise.

In some examples, the sounding response 304 may include an ICF/ICR inclusion indication (e.g., in situations in which the sounding sequence is planned to be done in a single TXOP).

In some examples, the sounding NSS 390 may indicate the NSS to be used in the sounding procedure.

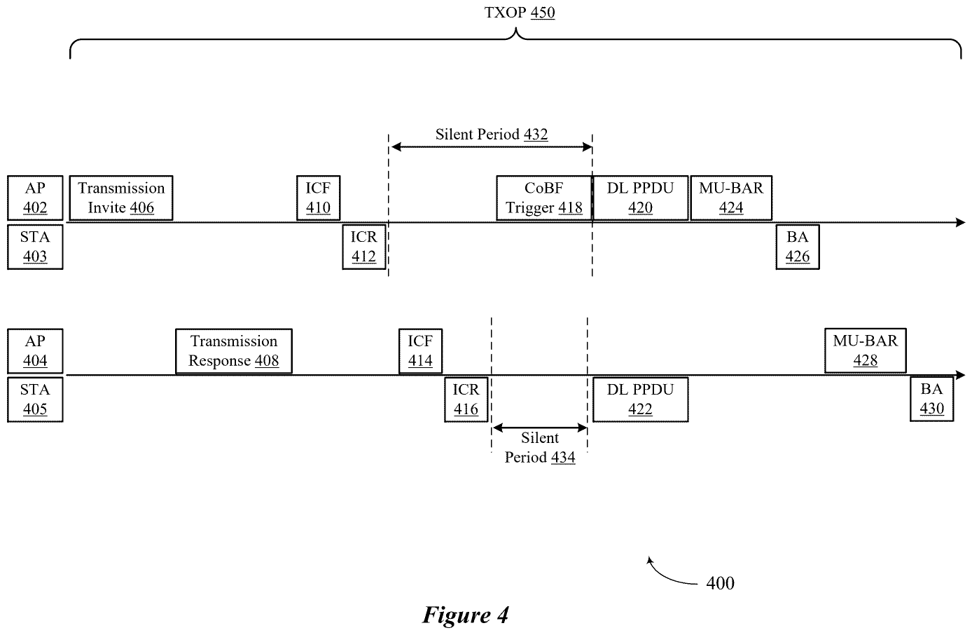

FIG. 4 shows an example of a CoBF transmission scheme 400 that supports coordinated beam forming frame formats. In some examples, the CoBF transmission scheme 400 may describe operations of the AP 402, the STA 403 associated with the AP 402, the AP 404, the STA 405 associated with the AP 404, or any combination thereof, within at least the TXOP 450. For example, the CoBF transmission scheme 400 may include a transmission invite 406, a transmission response 408, an ICF 410, and ICR 412, an ICF 414, an ICR 416, a CoBF trigger/sync 418, a DL PPDU 420, a DL PPDU 422, a multi-user block ACK request (MU-BAR), such as the MU-BAR 424, a block ACK, such as the BA 426, the MU-BAR 428, and a BA 430. In some examples, the ICF 410 may be combined with the transmission invite 406. In some examples, the ICF 414 may be combined with the transmission response 408. In some examples, the STA 403 may enforce or be involved with a silent period 432 and the STA 405 may enforce or be involved with a silent period 434. Details of portions of the CoBF transmission scheme 400 are described herein.

In some examples, the ICF 410 or the ICF 414 may include an indication to the STA 403 (e.g., which may be an enhanced multi-link single radio (EMLSR)/dynamic power save (DPS) STA) to use an extended timeout period. In some examples, the ICF 410 may include an indication of the duration of such an extended timeout period.

In some examples, these two parameters may be included in the User Info field addressed to the STA in the ICF 410 or the ICF 414. For example, the ICF 410 or the ICF 414 may include a 1 bit field for the extended timeout period, in which a value of 1 may indicate to use the extended timeout period. The ICF 410 or the ICF 414 may include an 8 bit field to indicate the extended timeout duration. In some examples, the duration may be indicated as a multiple of a base of 4 μs. In some examples, the duration may extend up to and including 1 ms. These two fields may be included in a User Info field with the AID field set to the AID of the recipient STA or included in a Feedback User Info field with the AID field set to 2008 to indicate feedback control information. In the case of multiple STAs being polled with the same ICF frame, those two fields may be included in one separate User Info field addressed to each of the polled STAs. If the two fields are included in a Feedback User Info field, then, in some example, only one of those feedback user info fields may be used, as it will be parsed and decoded by all recipient STAs.

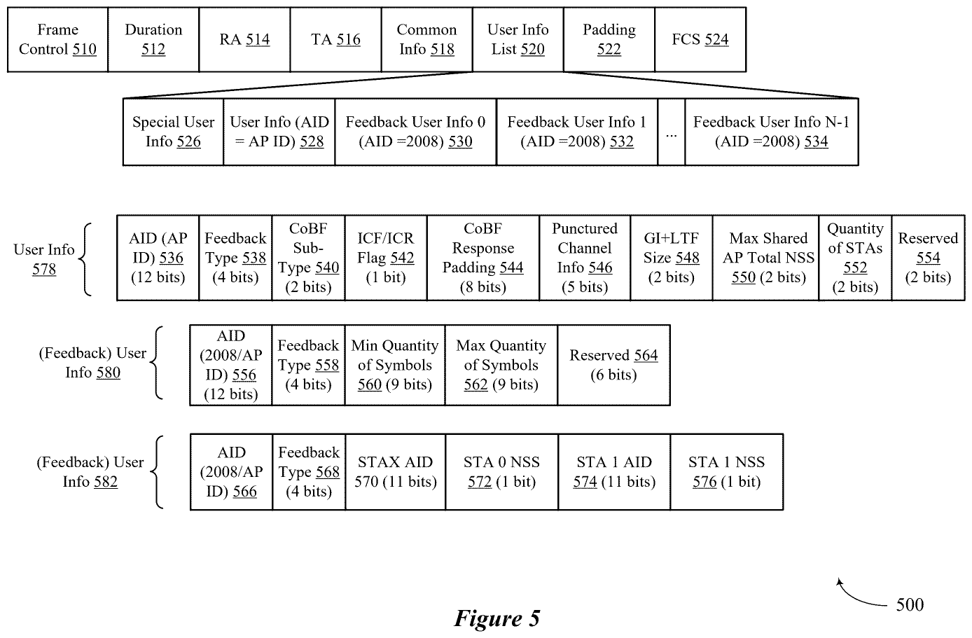

FIG. 5 shows an example of a CoBF transmission invite frame scheme 500 that supports coordinated beam forming frame formats. The CoBF transmission invite frame scheme 500 may at least a portion of a CoBF transmission invite frame, which may be an example of the transmission invite 406.

A CoBF transmission invite frame may include the frame control 510, the duration 512, the RA 514, the TA 516, the common info 518, the user info list 520, the padding 522, and the FCS 524. The user info list 520 may include the special user info 526, the user info 528, the feedback user info (0) 530, the feedback user info (1) 532, and so on as desired (e.g., until the feedback user info (N−1) 534.

A CoBF transmission invite frame may be a BSPR GI3 Tigger frame. For example, the CoBF transmission invite frame may be an individually addressed BSRP GI3 frame with the RA field set to the MAC address of the recipient AP (e.g., the AP 204). The CoBF transmission invite frame may carry CoBF transmission-related information in a user info field, such as the user info 528 or the user info 578, and one or more feedback user info fields, such as the feedback user info 530, the feedback user info 532, one or more other feedback user info fields, the feedback user info 534, the (feedback) user info 580, the (feedback) user info 582, or any combination thereof. In some examples, the CoBF transmission invite frame may include a single user info field with N feedback user info fields. Additionally, or alternatively, the CoBF transmission invite frame may include N+1 user fields. In some examples, In some examples, N may refer to a quantity of STAs involved with the CoBF operations (e.g., in a BSS).

In some examples, the user info list 520 may include a special user info 526 field, which may be used to report a physical layer (PHY) version identifier or bandwidth information in the case of 320 MHz BW (e.g., involving a UL BW Extension field).

In some examples, one or more extra info fields, (e.g., additional instances of the user info 578 or another type of user info field) may be included in the CoBF transmission invite frame to include intermediate frame check sequence (IFCS) preceding padding.

The user info 578 is one example of the user info 528. The user info 578 may include the AID 536, the feedback type 538, the CoBF sub-type 540, the ICF/ICR flag 542, the CoBF response padding 544, the punctured channel info 546, the guard interval (GI) and long training field (LTF) size, such as the GI+LTF size 548, the max shared AP total NSS 550, the quantity of STAs 552, and the reserved 554 portion.

In some examples, sizes, categories of some such elements (or other elements) may be as indicated in Table 1 herein. Further, Table 1 may indicate one or more elements that are included in the CoBF transmission invite frame.

TABLE 1

| | | Number |
|---|---|---|
| Category | | of Bits |
| PHY Common | Minimum Number of Data OFDM Symbols | 9 |
| Info | Maximum Number of Data OFDM Symbols | 9 |
| | PHY Version Identifier | 3 |
| | Bandwidth | 3 or 2 + 2 |
| | | as in TF |
| | Punctured Channel Information | 5 |
| | GI + LTF Size | 2 |
| | Maximum Total NSS Allowed for shared AP | 2 |
| | Number of CoBF Users in sharing BSS | 2 or 3 |
| Per-User Info | STA ID | 11 |
| in Sharing BSS | NSS | 1 |

In some examples, information described herein may be carried in the user info 528. However, in some cases, there may be more information than can be carried in the user info 528. In such cases, some of the information may be carried in a feedback user info 530 field (or in another feedback user info 530 field). Description of any information or fields as being included in the user info 528 may, therefore, be considered to also describe inclusion in the feedback user info 530 (or in another feedback user info field). Further, description of any information or fields as being included in the feedback user info 530 (or in another feedback user info 530 field) may, therefore, be considered to also describe inclusion in the user info 528. In some examples, the CoBF transmission invite frame may include a single user info field with N feedback user info fields. Additionally, or alternatively, the CoBF transmission invite frame may include N+1 user fields. In some examples, In some examples, N may refer to a quantity of STAs involved with the CoBF operations (e.g., in a BSS).

The (feedback) user info 580 is one example of the user info 528, the feedback user info 530, or other feedback user info field. The user info 580 may include the AID 556, the feedback type 558, the min quantity of symbols 560, the max quantity of symbols 562, and the reserved 564 portion.

The (feedback) user info 582 is one example of the user info 528, the feedback user info 530, or other feedback user info field. The user info 582 may include the AID 566, the feedback type 568, the STA 0 ID 570, the STA 0 NSS 572, the STA 1 AID 574, and the STA 1 NSS 576.

In some examples, feedback type 538, the feedback type 558, the feedback type 568, or another feedback type field may indicate the type of feedback included. In some examples, it may be set to a value of 2, to indicate the CoBF feedback. In some examples, options may include “2” for CoBF sounding or “3” for CoBF transmission or “4” for CoBF trigger or sync.

In some examples, the CoBF sub-type 540 may be set to a value (e.g., 1) to indicate the CoBF transmission phase or CoBF transmission operations. In some examples, options for the value may include 0 to indicate CoBF sounding operations, 1 to indicate CoBF transmission operations, 2 to indicate CoBF trigger/sync operations, and 3 may be a reserved value. Additionally, or alternatively, a single feedback type value may be used for all MAPC and a subtype field to indicate the CoBF sounding procedure or the CoBF transmission procedure.

In some examples, the ICF/ICR flag 542 may indicate whether the ICF/ICR is to be performed during the transmission procedure. For example, the ICF/ICR flag 542 may be set to 1 when ICF/ICR is included in the sequence and 0 otherwise.

In some examples, the CoBF response padding 544 may indicate a padding delay that is to be included in the CoBF response (e.g., at the end of the CoBF response).

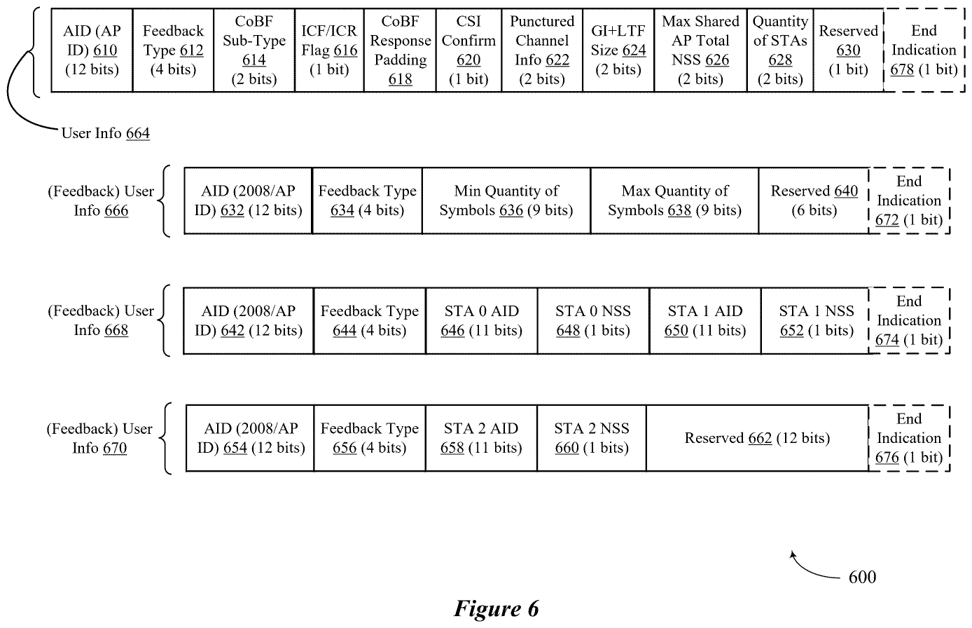

FIG. 6 shows an example of a CoBF transmission invite frame scheme 600 that supports coordinated beam forming frame formats. The CoBF transmission invite frame scheme 600 depicts a case in which a last feedback user info field (e.g., the (feedback) user info 582 field, may be repeated once more to accommodate information for one or more additional STAs. For example, a CoBF transmission invite frame may include the user info 664 field, the (feedback) user info 666, the (feedback) user info 668, and the (feedback) user info 670. Thus, the (feedback) user info 670 may be a copy of the (feedback) user info 668, except that, in cases in which the (feedback) user info 670 only includes information for a single STA, that the (feedback) user info 670 includes the reserved 662 portion (e.g., where information for another STA would otherwise be included).

The user info 664 may include the AID 610, the feedback type 612, the CoBF sub-type 614, the ICF/ICR flag 616, the CoBF response padding 618, the CSI confirm 620, the punctured channel info 622, GI+LTF size, such as the GI+LTF size 624, the max shared AP total NSS 626, the quantity of STAs 628, the reserved 630 portion, and the end indication 678.

The (feedback) user info 666 is one example of the user info 528, the feedback user info 530, or other feedback user info field. The (feedback) user info 580 may include the AID 632, the feedback type 634, the min quantity of symbols 636, the max quantity of symbols 638, the reserved 640 portion, and the end indication 672.

The (feedback) user info 668 is one example of the user info 528, the feedback user info 530, or other feedback user info field. The user info 582 may include the AID 642, the feedback type 644, the STA 0 ID 646, the STA 0 NSS 648, the STA 1 AID 650, the STA 1 NSS 652, and the end indication 674.

The (feedback) user info 670 is one example of the user info 528, the feedback user info 530, or other feedback user info field. The user info 582 may include the AID 654, the feedback type 656, the STA 0 ID 658, the STA 0 NSS 660, the reserved 662 portion, and the end indication 676.

In some examples, to facilitate the parsing of these the user info 666 and one or more (feedback) user info fields (e.g., the user info 664, the (feedback) user info 666, the (feedback) (feedback) user info 668, and the (feedback) user info 670) is to add a 1-bit indication at the end of each user info field to indicate whether more User Info fields are coming after or not. Such an indication is represented by the end indication 672, the end indication 674, the end indication 676, and the end indication 678.

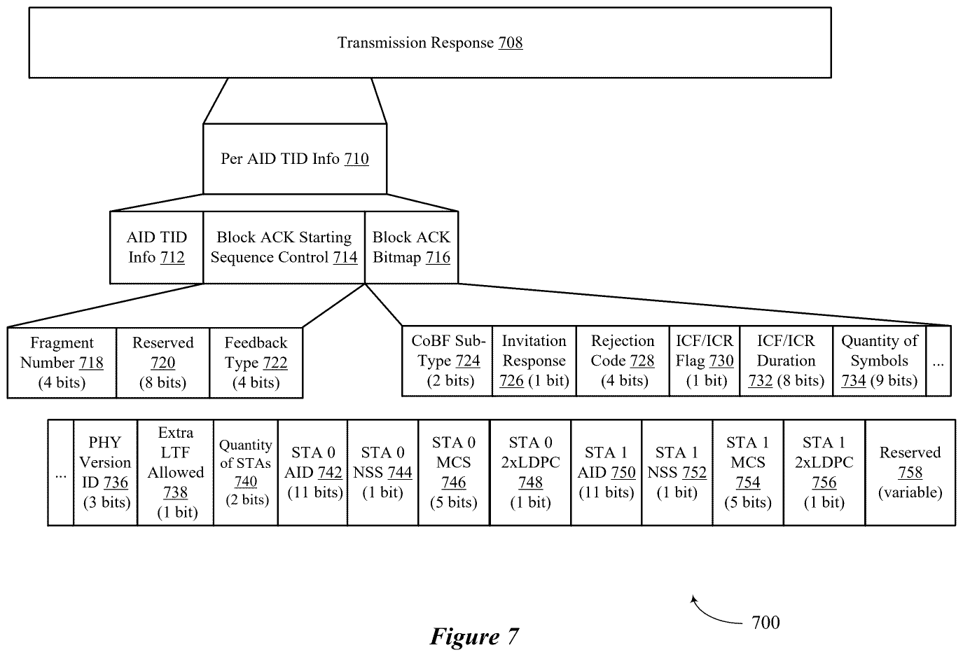

FIG. 7 shows an example of a CoBF transmission response frame scheme 700 that supports coordinated beam forming frame formats. The CoBF transmission response frame scheme 700 may involve at least a portion of a CoBF transmission response 708, which may be an example of the transmission response 408. The per-AID TID info 710 may be an M-BA frame. In some examples, the transmission response 708 may include one or more elements included in the sounding response 304 (e.g., because the sounding response 304 and the transmission response 708 may both be M-BA frames and may therefore both include one or more elements that are the same). For example, the transmission response 708 may include one or more portions similar to those of the sounding response 304, including frame control, duration, RA, TA, BA control, BA info, padding, and FCS. The per-AID TID info 710 may include one or more fields similar to the per-AID TID info 370. The per-AID TID info 710 may be an example of a field similar to the per-AID TID info 370, but may also include some differences.

In some examples, the per-AID TID info 710 may be dedicated for CoBF transmission-related information. In some examples, the per-AID TID info 710 field may be included in any portion of the CoBF transmission response.

In some examples, the per-AID TID info 710 may include the AID TID info 712, the block ACK starting sequence control 714, and the block ACK bitmap 716. In some examples, the sequence control 714 may include the fragment number 718, the reserved 720 portion, and the feedback type 722. The block ACK bitmap 716 may include the CoBF sub-type 724, the invitation response 726, the rejection code 728, the ICF/ICR flag 730, the ICF/ICR duration 732, the quantity of symbols 734, the PHY version ID 736, the extra LTF allowed 738, the quantity of STAs 740, the STA 0 AID 742, the STA 0 NSS 744, the STA 0 MCS 746, the STA 0 2xLDPC 748, the STA 1 AID 750, the STA 1 NSS 752, the STA 1 MCS 754, the STA 1 2xLDPC 756, and the reserved 758 portion.

In some examples, the feedback type 722 may indicate the type of feedback included. In some examples, it may be set to a value of 2, to indicate CoBF.

In some examples, the CoBF sub-type 724 may be set to a value (e.g., 1) to indicate the transmission phase. In some examples, options for the value may include 0 for the sounding phase and 1 for the transmission phase. Additionally, or alternatively, a single feedback type value may be used for all multi-AP coordination (MAPC) and a subtype field to indicate the CoBF sounding procedure or the CoBF transmission procedure.

In some examples, the invitation response 726 may indicate whether the sounding invite 302 is accepted or rejected. The rejection code 728 may indicate one or more reasons for the rejection, such as unavailability, missing CSI, a quantity of buffered traffic that does not satisfy a buffered traffic threshold, unavailability of one or more STAs, a quantity of STA resources that does not satisfy a resource threshold (e.g., STA's spatial streams or a quantity of available SSs does not satisfy the threshold). In some examples, a value of 1 may indicate acceptance of the sounding invite 302 and 0 otherwise.

In some examples, the ICF/ICR flag 730 may indicate whether the ICF/ICR is to be performed during the transmission procedure. For example, the ICF/ICR flag 730 may be set to 1 when ICF/ICR is included in the sequence and 0 otherwise.

In some examples, the ICF/ICR duration 732 may indicate a duration of one or more ICFs, ICRs, or pairs of ICF/ICRs.

In some examples, an IFCS field may be included in the transmission response 708 (e.g., which may be an M-BA frame). In some examples, this may allow checking for frame errors before additional processing. Provision of the IFCS field may also provide consistency (e.g., by having the IFCS precede one or more padding fields, such as those added for UHR-related purposes). The IFCS field may be included at any point within the transmission response 708, including within the per-AID TID info 710 or a separate per-AID TID info field.

In some examples, the transmission response 708, the per-AID TID info 710, one or more elements of either, or any combination thereof, may be aligned (e.g., in terms of byte alignment) with respect to one or more common information fields, one or more per-user information fields, or both.

In some examples, in cases of rejection of a transmission invite, the transmission response 708 may employ a shorter version of the structure described herein. For example, the block ACK bitmap 716 may be shortened, and any one or more fields included in the block ACK bitmap 716 may be repurposed as reserved fields.

In some examples, sizes, categories of some such elements (or other elements) may be as indicated in Table 2 herein. Additionally, or alternatively, Table 2 may list one or more elements that are included in the transmission response 708.

TABLE 2

| | | Number |
|---|---|---|
| Category | | of Bits |
| PHY Common | Suggested Number of Data OFDM Symbols | 9 |
| Info | PHY Version Identifier | 3 |
| | Extra LTF Allowed | 1 |
| | Number of CoBF Users in shared BSS | 2 or 3 |
| Per-User Info | STA ID | 11 |
| in Shared BSS | MCS | 5 |
| | NSS | 1 |
| | 2xLDPC | 1 |

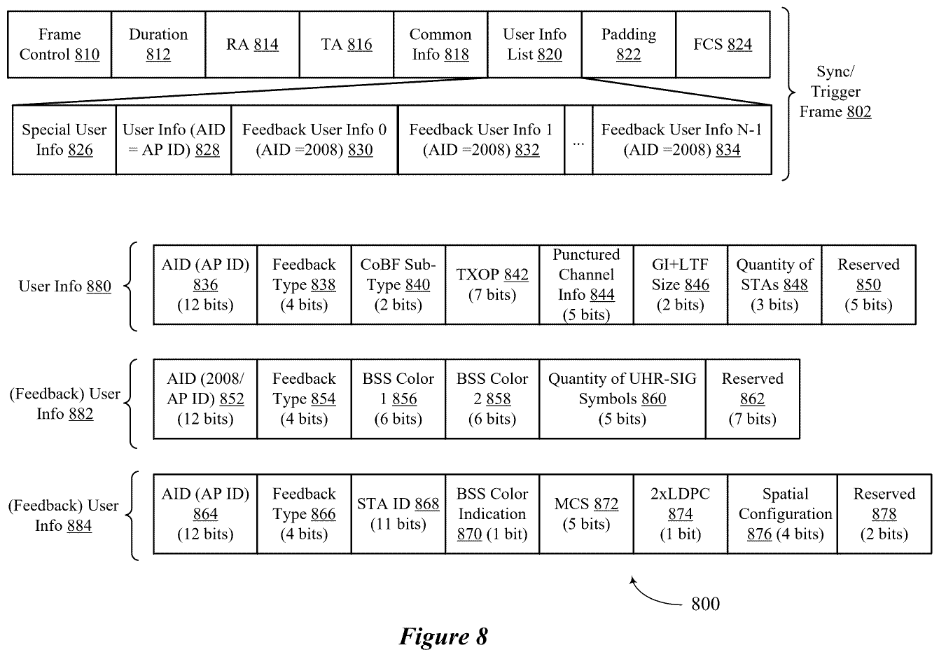

FIG. 8 shows an example of a sync/trigger frame scheme 800 that supports coordinated beam forming frame formats. The trigger frame scheme 800 may involve a sync/trigger frame 802. The trigger frame 802 may be a BSPR GI3 Tigger frame. For example, the trigger frame 802 may be an individually addressed BSRP GI3 frame with the RA field set to the MAC address of the recipient AP (e.g., the AP 204). The CoBF trigger (sync) frame may carry CoBF transmission-related information in a user info field, such as the user info 880, and one or more feedback user info fields, such as the feedback user info 830, the feedback user info 832, the feedback user info 834, the (feedback) user info 882, the (feedback) user info 884 or any combination thereof. In some examples, the CoBF sync/trigger frame may include a single user info field (e.g., user info 880) with N feedback user info fields (e.g., (feedback) user info 882 and (feedback) user info 884). Additionally, or alternatively, the CoBF transmission invite frame may include N+1 user fields. In some examples, N may refer to a quantity of STAs involved with the CoBF operations (e.g., in a BSS).

In some examples, information described herein may be carried in the user info 828. However, in some cases, there may be more information than can be carried in the user info 828. In such cases, some of the information may be carried in a feedback user info 830 field (or in another feedback user info field). Description of any information or fields as being included in the user info 828 may, therefore, be considered to also describe inclusion in the feedback user info 830 (or in another feedback user info field). Further, description of any information or fields as being included in the feedback user info 830 (or in another feedback user info field) may, therefore, be considered to also describe inclusion in the user info 828.

In some examples, the sync/trigger frame 802 may include the frame control 810, the duration 812, the RA 814, the TA 816, the common info 818, the user info list 820, the padding 822, the FCS 824, or any combination thereof.

In some examples, the user info list 820 may include a special user info 826 field, which may be used to report a physical layer (PHY) version identifier or bandwidth information in the case of 320 MHz BW (e.g., involving a UL BW Extension field).

In some examples, one or more extra info fields, (e.g., additional instances of the user info 828 or another type of user info field) may be included in the CoBF transmission trigger (sync) frame to include intermediate frame check sequence (IFCS) preceding padding.

The user info 880 is one example of the user info 828. The user info 880 may include one or more fields, such as the AID 836, the feedback type 838, the CoBF sub-type 840, the TXOP 842, the punctured channel info 844, the GI+LTF size 846, the quantity of STAs 848, and the reserved 850 portion.

In some examples, the (feedback) user info 882 field is one example of the user info 828, the (feedback) user info 830, the (feedback) user info 832, the (feedback) user info 834, or another feedback user info field. The (feedback) user info 882 field may include one or more fields, such as the AID 852, the feedback type 854, the BSS color 1 856, the BSS color 2 858, the quantity of UHR-SIG symbols 860, and the reserved 862 portion.

In some examples, the (feedback) user info 884 field may be one example of the user info 828, the feedback user info 830, the feedback user info 832, the feedback user info 834, or another feedback user info field. The (feedback) user info 884 field may include one or more fields, such as the AID 864, the feedback type 866, the STA ID 868, the BSS color indication 870, the MCS 872, the 2xLDPC 874, the spatial configuration 876, and the reserved 878 portion.

In some examples, feedback type 838, the feedback type 854, the feedback type 866, or another feedback type field may indicate the type of feedback included. In some examples, it may be set to a value of 3, to indicate CoBF sync. In some examples, options may include “2” for CoBF sounding or “3” for CoBF transmission or “4” for CoBF trigger/sync.

In some examples, the CoBF sub-type 840 may be set to a value (e.g., 2) to indicate the trigger or synchronization operations. In some examples, (e.g., in which the sync/trigger frame 802 may be a BSRP GI3 TF variant or in other examples), options for values of the CoBF sub-type 840 field may include three options plus one reserved value: In some examples, options for the value may include 0 to indicate CoBF sounding operations (e.g., involving a sounding invite), 1 to indicate CoBF transmission operations (e.g., to involving a transmission invite), 2 to indicate CoBF trigger/sync operations, and 3 may be a reserved value. Additionally, or alternatively, a single feedback type value may be used for all MAPC and a subtype field to indicate the CoBF sounding procedure or the CoBF transmission procedure.

In some examples, sizes, categories of some such elements (or other elements) may be as indicated in Table 3 herein. Additionally, or alternatively, Table 2 may list one or more elements that are included in the sync/trigger frame 802. For example, the PHY version identifier and the bandwidth indicated in Table 3 may be included in a common info field, a special user info field, or any combination thereof.

TABLE 3

| | | Number |
|---|---|---|
| Category | | of Bits |
| Control | ‘CoBF Sync’ | TBD |
| PHY Common | Length | 12 |
| Info | PHY Version Identifier | 3 |
| | Bandwidth | 3 or 2 + 2 |
| | | as in TF |
| | Punctured Channel Information | 5 |
| | BSS Color 1, BSS Color 2 | 6 each |
| | TXOP | 7 |
| | Number of UHR-SIG Symbols | 5 |
| | GI + LTF Size | 2 |
| | Number Of UHR-LTF Symbols | 3 |
| | Number of CoBF Users | 3 |
| Per-User Info | STA ID | 11 |
| in Both BSS | BSS Color Indication | 1 |
| | MCS | 5 |
| | Spatial Configuration | 4 |
| | 2xLDPC | 1 |

The user info 880, the (feedback) user info 882, and the (feedback) user info 884 and the sync/trigger frame 802 may demonstrate an example of using a single feedback user info field to carry the information for a single user. In these techniques, one or more fields in common info and special user info fields may be reused. For example, the UL length may be repurposed to the length field. Further, the quantity of UHR-LTF symbols may be repurposed.

In some examples, this example of using a single feedback user info field to carry the information for a single user may unify the designs, so that fields appear in both the transmission invite frame and the sync/trigger frame 802. Such common or corresponding fields may include the punctured channel info 844, the GI+LTF size 846, and the quantity of STAs 848. In some examples, the quantity of the user fields to carry per-user info equals the quantity of CoBF users (e.g., as indicated in the quantity of STAs 848).

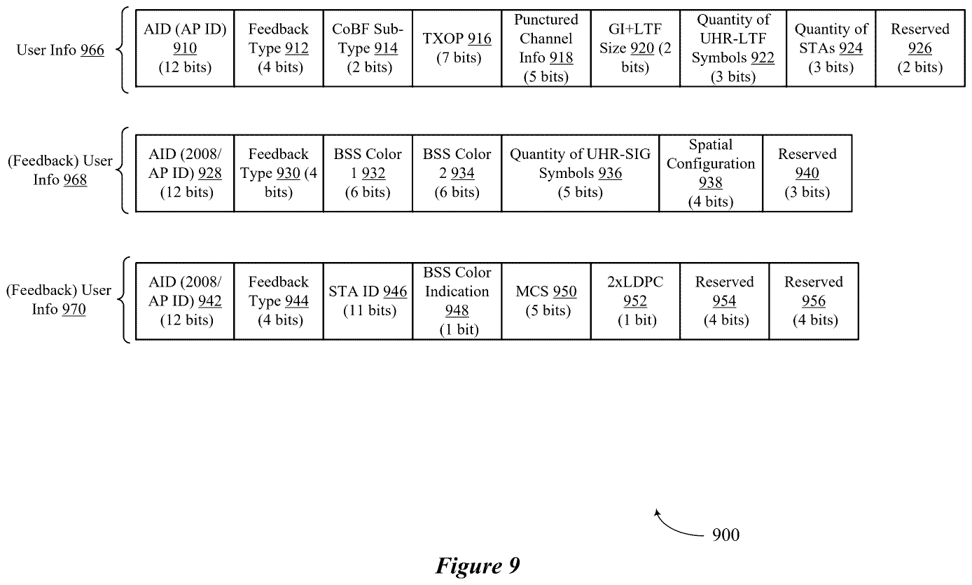

FIG. 9 shows an example of a sync/trigger frame scheme 900 that supports coordinated beam forming frame formats. In some examples, the trigger frame scheme 900 may be a variation of the trigger frame scheme 800 that uses a common spatial configuration for multiple users or all users. For example, the spatial configuration 938 included in the (feedback) user info 968 may indicate the common spatial configuration. Elements depicted in the trigger frame scheme 900 that bear names similar to other elements described in trigger frame scheme 800 are to be considered as the same or similar elements, and descriptions of such elements in the trigger frame scheme 800 may, in some examples, be applied to the similarly-named elements in the trigger frame scheme 900.

As a result, the arrangement of fields in trigger frame scheme 900 may differ from the arrangement of fields in trigger frame scheme 800 in some examples.

In some examples, the user info 966 may include the AID 910, the feedback type 912, the CoBF sub-type 914, the TXOP 916, the punctured channel info 918, the GI+LTF size 920, the quantity of UHR-LTF symbols 922, the quantity of STAs 924, and the reserved 926 portion.

In some examples, the (feedback) user info 968 may include the AID 928, the feedback type 930, the BSS color 1 932, the BSS color 2 934, the quantity of UHR-SIG symbols 936, the spatial configuration 938, and the reserved 940 portion.

In some examples, the (feedback) user info 970 may include the AID 942, the feedback type 944, the STA ID 946, the BSS color indication 948, the MCS 950, the 2xLDPC 952, the reserved 954 portion, and the reserved 956 portion.

In some examples, the (feedback) user info 970 may be associated with a single STA, identifier by the STA ID 946. In some examples, quantity of the user fields to carry per-user info (e.g., a quantity of instances of the (feedback) user info 970) may be equal to the quantity of CoBF users (e.g., as indicated in the quantity of STAs 924).

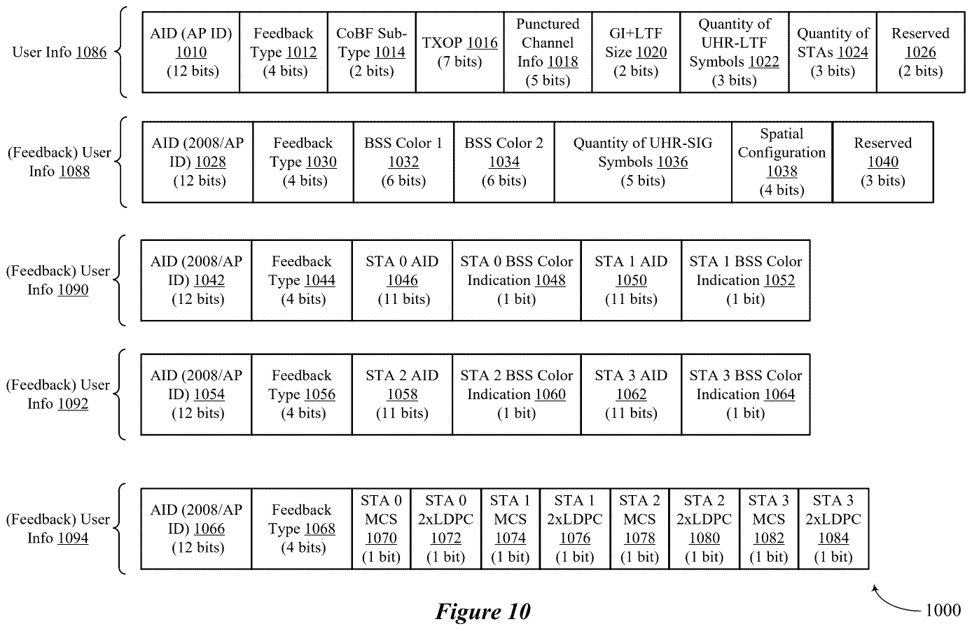

FIG. 10 shows an example of a sync/trigger frame scheme 1000 that supports coordinated beam forming frame formats. In some examples, the trigger frame scheme 1000 may be a variation of the trigger frame scheme 800 that uses separate user info field designs for a single user's information. For example, in cases that involve two total CoBF users, the sync/trigger frame may include a single (feedback) user info fields, such as the (feedback) user info 1090 or the (feedback) user info 1092. For example, in cases that involve three or four total CoBF users, the sync/trigger frame may include two (feedback) user info fields, such as the (feedback) user info 1090 and the (feedback) user info 1092. In some examples, only a single (feedback) user info 1094 field may be included in the sync/trigger frame.

It should be noted that elements depicted in the trigger frame scheme 1000 that bear names similar to other elements described in trigger frame scheme 800 or the trigger frame scheme 900 are to be considered as the same or similar elements, and descriptions of such elements in the trigger frame scheme 800 may, in some examples, be applied to the similarly-named elements in the trigger frame scheme 1000.

In some examples, the user info 1086 may include the AID 1010, the feedback type 1012, the CoBF phase 1014, the TXOP 1016, the punctured channel info 1018, the GI+LTF size 1020, the quantity of UHR-LTF symbols 1022, the quantity of STAs 1024, and the reserved 1026 portion.

In some examples, the (feedback) user info 1088 may include the AID 1028, the feedback type 1030, the BSS color 1 1032, the BSS color 2 1034, the quantity of UHR-SIG symbols 1036, the spatial configuration 1038, and the reserved 1040 portion.

In some examples, the (feedback) user info 1090 may include the AID 1042, the feedback type 1044, the STA 0 AID 1046, the STA 0 BSS color indication 1048, the STA 1 AID 1050, and the STA 1 BSS color indication 1052. In some examples, the (feedback) user info 1090 may be capable of carrying information for multiple STAs (e.g., the STA 0 and the STA 1).

In some examples, the (feedback) user info 1092 may include the AID 1054, the feedback type 1056, the STA 0 AID 1058, the STA 0 BSS color indication 1060, the STA 1 AID 1062, and the STA 1 BSS color indication 1064. In some examples, the (feedback) user info 1092 may be capable of carrying information for multiple STAs (e.g., the STA 2 and the STA 3).

In some examples, the (feedback) user info 1094 may include the AID 1066, the feedback type 1068, the STA 0 MCS 1070, the STA 0 2xLDPC 1072, the STA 1 MCS 1074, the STA 1 2xLDPC 1076, the STA 2 MCS 1078, the STA 2 2xLDPC 1080, the STA 3 MCS 1082, and the STA 3 2xLDPC 1084.

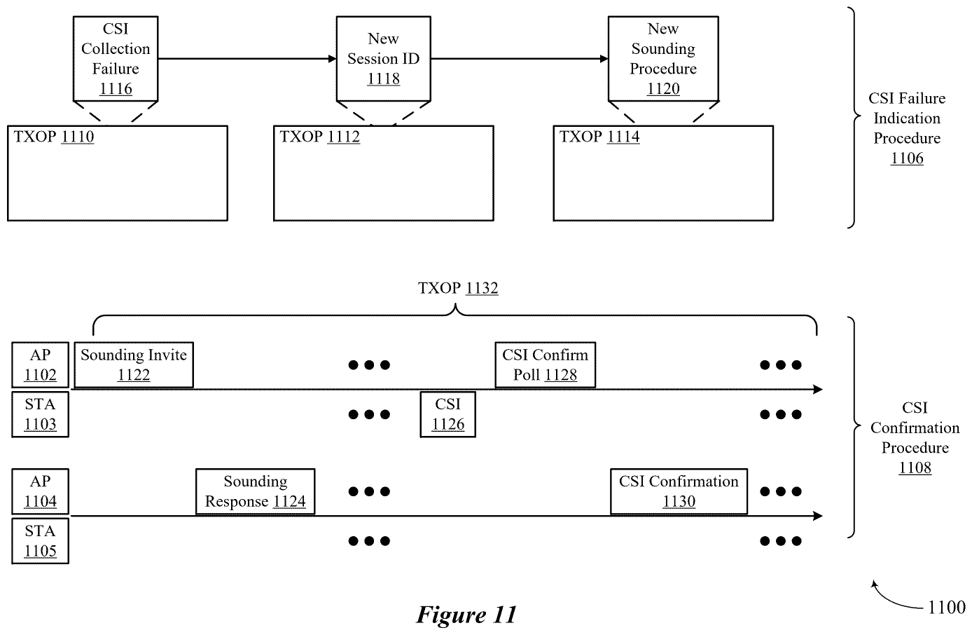

FIG. 11 shows an example of a CoBF CSI scheme 1100 that supports coordinated beam forming frame formats or sequences. The CoBF CSI scheme 1100 may include the CSI failure indication procedure 1106 and the CSI confirmation procedure 1108.

In some examples, it may be desirable for an AP to confirm successful reception of cross-BSS CSI with another AP. It may further be desirable for additional procedures to obtain the cross-BSS CSI in cases in which the cross-BSS CSI is not successfully obtained.

For example, in the CSI failure indication procedure 1106, a first AP may experience the CSI collection failure 1116 from a sounding sequence initiated by a second AP during the TXOP 1110. Thus, in the following TXOP 1112, the first AP may use the new session ID 1118 (which differs from a session ID associated with the TXOP 1110). Thus, by using the new session ID 1118, the first AP may implicitly indicate to the second AP the CSI collection failure 1116 and subsequently the second AP initiates the sounding procedure 1120 in the TXOP 1114 (e.g., using the new session ID 1118) in efforts to aid the first AP to successfully obtain the cross-BSS CSI.

For example, in the CSI confirmation procedure 1108 (which may be associated with one or more TXOPs, such as the EXOP 1132), the AP 1102 (with which the STA 1103 is associated) may transmit the sounding invite 1122 and the AP 1104 (with which the STA 1105 is associated) may respond with the sounding response 1124. The STA 1103 may transmit the CSI 1126, which may be decoded by the AP 1104. In response, the AP 1102 may transmit the CSI confirm poll 1128 to confirm whether the AP 1104 successfully received the CSI. If so, the AP 1104 may transmit the CSI confirmation 1130 or indicate the successful receipt of the CSI. However, if the AP 1104 did not successfully obtain the CSI information the AP may not transmit the confirmation 1130 or may indicate the failure in the CSI confirmation 1130.

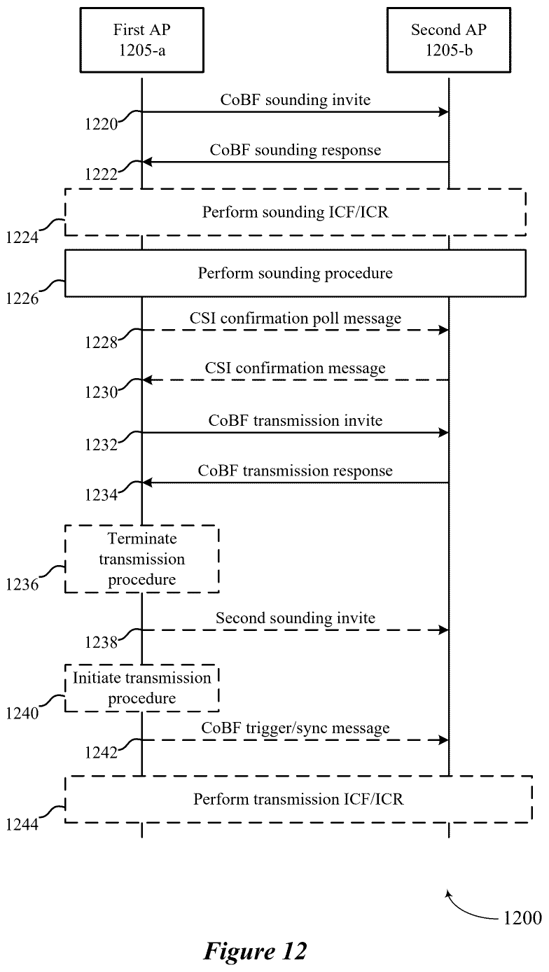

FIG. 12 shows an example of a process flow 1200 that supports coordinated beam forming frame formats.

The process flow 1200 may implement various aspects of the present disclosure described herein. The elements described in the process flow 1200 (e.g., first AP 1205-a and second AP 1205-b) may be examples of similarly named elements described herein.

In the following description of the process flow 1200, the operations between the various entities or elements may be performed in different orders or at different times. Some operations may also be left out of the process flow 1200, or other operations may be added. Although the various entities or elements are shown performing the operations of the process flow 1200, some aspects of some operations may also be performed by other entities or elements of the process flow 1200 or by entities or elements that are not depicted in the process flow, or any combination thereof.

In some examples, at 1220, the first AP 1205-a may transmit, in association with a coordinated beamforming (CoBF) sounding procedure, a CoBF sounding invite message that may include one or more first user information fields for a second AP 1205-b. In some examples, the CoBF sounding invite message may include one or more user information fields that comprise an indication of a feedback type, an indication of a CoBF phase, an indication of a session identifier, an indication of a sound type, an initial control frame (ICF)/initial control response (ICR) presence indicator, an indication of a quantity of spatial streams, a channel state information reception confirmation indication, or any combination thereof. In some examples, each of the one or more user information fields are identified by an association identifier that may indicate control feedback information or are identified by an identifier of the first AP assigned in a CoBF agreement establishment procedure. In some examples, at least one of the one or more user information fields is capable of carrying user information associated with multiple STAs of the one or more STAs associated with the first AP.

In some examples, the first AP 1205-a may indicate, based on a failure to obtain cross-basic service set (BSS) CoBF channel state information (CSI) in a previous transmission opportunity, a session identifier in the CoBF sounding invite message that differs from a previous session identifier associated with the previous transmission opportunity to indicate the failure to obtain the cross-BSS CoBF CSI.

In some examples, at 1222, the first AP 1205-a may receive, based on the CoBF sounding invite message, a CoBF sounding response message that may include a first per-association identifier (AID) traffic identifier (TID) information field. In some examples, the first per-AID TID information field may include an indication of a feedback type, an indication of a CoBF phase, an indication of an invitation response, a rejection code associated with rejection of the CoBF sounding invite message, an indication of a quantity of spatial streams, or any combination thereof.

In some examples, at 1224, the first AP 1205-a may transmit, to the one or more STAs associated with the first AP and based on the CoBF sounding response message, a sounding initial control frame (ICF). Additionally, or alternatively, the first AP 1205-a may receive, from the one or more STAs associated with the first AP and based on the sounding ICF, a sounding initial control response (ICR) and the performance of the CoBF sounding procedure is further based on the sounding ICR. Further, in some examples, the second AP may transmit, to one or more second STAs associated with the second AP and based on the CoBF sounding response message, a sounding ICF. Additionally, or alternatively, the second AP 1205-b may receive, from the one or more second STAs associated with the second AP and based on the sounding ICF, a sounding ICR. In some examples, performance of the CoBF sounding procedure (e.g., operations performed by the second AP 1205-b) is based on the sounding ICR.

In some examples, at 1226, the first AP 1205-a may perform, based on the CoBF sounding invite message and the CoBF sounding response message, the CoBF sounding procedure.

In some examples, at 1228, the first AP 1205-a may transmit, based on the reception of the CoBF sounding response message, a channel state information (CSI) confirmation poll message that solicits a CSI confirmation message.

In some examples, at 1230, the first AP 1205-a may receive, based on the CSI confirmation poll message, the CSI confirmation message that may indicate whether CSI was successfully obtained.

In some examples, at 1232, the first AP 1205-a may transmit, in association with a CoBF transmission procedure, a CoBF transmission invite message that may include one or more second user information fields for the second AP 1205-b, the one or more second user information fields that may include CoBF operation-related information and information for one or more stations (STAs) associated with the first AP. In some examples, the CoBF transmission invite message may include one or more user information fields that comprise an indication of a feedback type, an indication of a CoBF phase, an initial control frame (ICF)/initial control response (ICR) presence indicator, an amount of padding to be included in the CoBF transmission response message, punctured channel information, GI+LTF Size, a maximum quantity of AP spatial streams, a quantity of stations, a minimum quantity of symbols, a maximum quantity of symbols, or any combination thereof. In some examples, each of the one or more user information fields are identified by an association identifier of 2008 that may indicate control feedback information or identified by an identifier of a second AP 1205-b assigned by the first AP during a CoBF agreement establishment procedure. In some examples, at least one of the one or more feedback user information fields is capable of carrying user information associated with multiple STAs of the one or more STAs associated with the first AP.

In some examples, at 1234, the first AP 1205-a may receive, based on the CoBF transmission invite message, a CoBF transmission response message that may include at least a second per-AID TID information field. In some examples, the second per-AID TID information field may include an indication of a feedback type, an indication of a CoBF phase, an indication of an invitation response, a rejection code associate with rejection of the CoBF transmission invite message, an initial control frame (ICF)/initial control response (ICR) presence indicator, an indication of a duration of an ICR/ICR frame exchange, a quantity of symbols, a physical layer version identifier, a location triggering function permission indication, a quantity of stations, or any combination thereof.

In some examples, the first AP 1205-a may receive, in the CoBF transmission response message, an indication of a failure to obtain CoBF channel state information (CSI).

In some examples, at 1236, the first AP 1205-a may terminate, based on the reception of the indication of the failure to obtain the CoBF CSI, the CoBF transmission procedure.

In some examples, at 1238, the first AP 1205-a may transmit, based on the termination of the CoBF transmission procedure, a second sounding invite message associated with a second sounding procedure.

In some examples, at 1240, the first AP 1205-a may initiate the CoBF transmission procedure based at least in part on the CoBF transmission response message. In some examples, the performance of the CoBF transmission procedure is based on the CoBF trigger message.

In some examples, at 1242, the first AP 1205-a may transmit a CoBF trigger/synchronization message that may indicate triggering information for the CoBF transmission procedure, at least a portion of the triggering information indicated in one or more third user information fields for the second AP 1205-b. In some examples, each third user information field of the one or more third user information fields is capable of carrying user information associated with a single STA of the one or more STAs associated with the first AP and common user information for CoBF operations. Additionally, or alternatively, in some examples, each third user information field of the one or more third user information fields is capable of carrying user information associated with multiple STAs of the one or more STAs associated with the first AP and the common user information for CoBF operations. In some examples, the one or more third user information fields indicate a common spatial configuration for the one or more STAs associated with the first AP.

In some examples, at 1244, the first AP 1205-a may transmit, to the one or more STAs associated with the first AP and based on the CoBF transmission response message, a transmission initial control frame (ICF). Additionally, or alternatively, the first AP 1205-a may receive, from the one or more STAs and based on the transmission ICF, a transmission initial control response (ICR) and the performance of the CoBF transmission procedure is further based on the transmission ICR.

In some examples, the transmission ICF may include a timeout field that indicate whether an extended timeout period is to be enforced, the timeout field included in a separate user information field, in a common information field, or in a special user information field. In some examples, the transmission ICF may include a timeout duration field that indicate a duration of the extended timeout period, the timeout field included in the separate user information field, in the common information field, or in the special user information field.

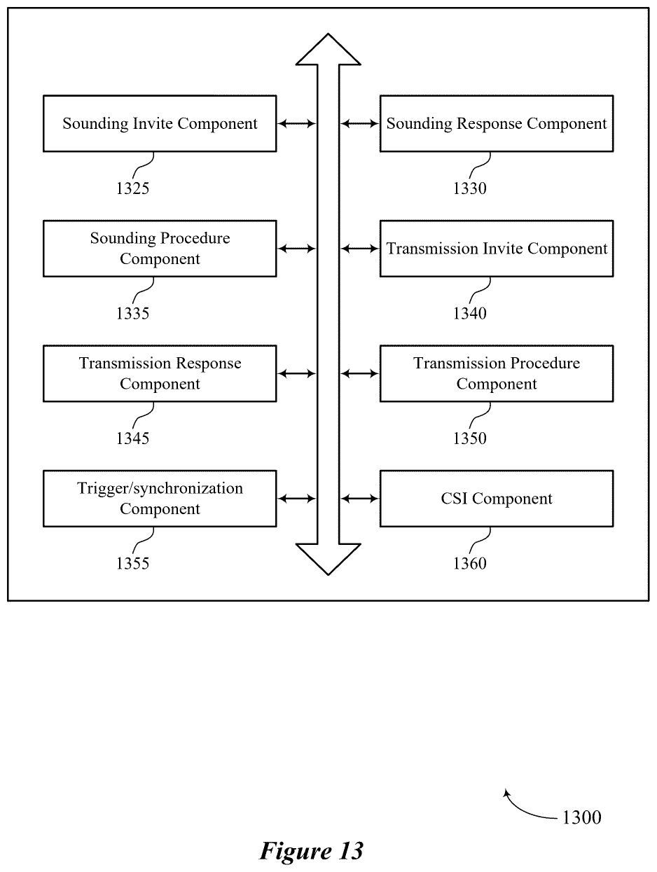

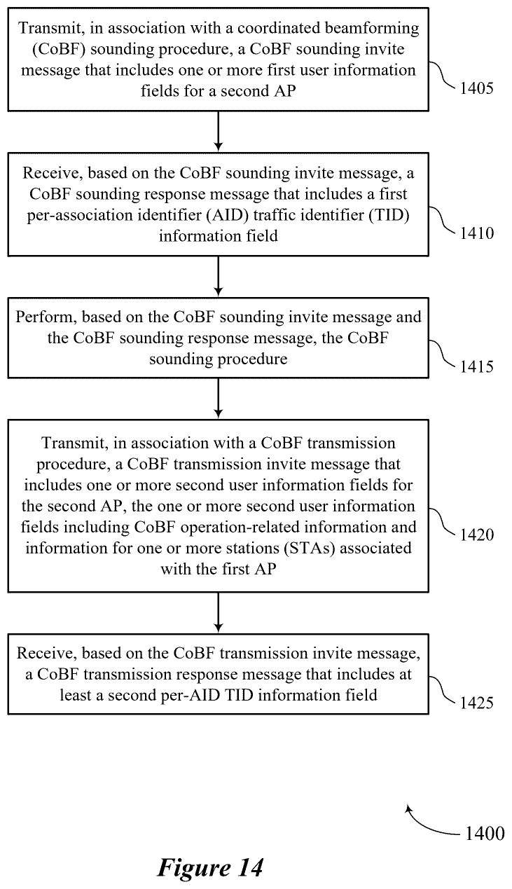

FIG. 13 shows a block diagram of an example wireless communication device 1300 that supports coordinated beam forming frame formats. In some examples, the wireless communication device 1300 is configured to perform the process 1400 described with reference to FIG. 14. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a sounding invite component 1325, a sounding response component 1330, a sounding procedure component 1335, a transmission invite component 1340, a transmission response component 1345, a transmission procedure component 1350, a trigger/synchronization component 1355, and a CSI component 1360. Portions of one or more of the sounding invite component 1325, the sounding response component 1330, the sounding procedure component 1335, the transmission invite component 1340, the transmission response component 1345, the transmission procedure component 1350, the trigger/synchronization component 1355, and the CSI component 1360 may be implemented at least in part in hardware or firmware. For example, one or more of the sounding invite component 1325, the sounding response component 1330, the sounding procedure component 1335, the transmission invite component 1340, the transmission response component 1345, the transmission procedure component 1350, the trigger/synchronization component 1355, and the CSI component 1360 may be implemented at least in part by at least a processor or a modem. In some examples, portions of one or more of the sounding invite component 1325, the sounding response component 1330, the sounding procedure component 1335, the transmission invite component 1340, the transmission response component 1345, the transmission procedure component 1350, the trigger/synchronization component 1355, and the CSI component 1360 may be implemented at least in part by a processor and software in the form of processor-executable code stored in memory.

The wireless communication device 1300 may support wireless communications in accordance with examples as disclosed herein. The sounding invite component 1325 is configurable or configured to transmit, in association with a coordinated beamforming (CoBF) sounding procedure, a CoBF sounding invite message that includes one or more first user information fields for a second AP. The sounding response component 1330 is configurable or configured to receive, based on the CoBF sounding invite message, a CoBF sounding response message that includes a first per-association identifier (AID) traffic identifier (TID) information field. The sounding procedure component 1335 is configurable or configured to perform, based on the CoBF sounding invite message and the CoBF sounding response message, the CoBF sounding procedure. The transmission invite component 1340 is configurable or configured to transmit, in association with a CoBF transmission procedure, a CoBF transmission invite message that includes one or more second user information fields for the second AP, the one or more second user information fields including CoBF operation-related information and information for one or more stations (STAs) associated with the first AP. The transmission response component 1345 is configurable or configured to receive, based on the CoBF transmission invite message, a CoBF transmission response message that includes at least a second per-AID TID information field.

In some examples, the transmission procedure component 1350 is configurable or configured to initiate the CoBF transmission procedure based at least in part on the CoBF transmission response message.

In some examples, the trigger/synchronization component 1355 is configurable or configured to transmit a CoBF trigger/synchronization message that indicates triggering information for the CoBF transmission procedure, at least a portion of the triggering information indicated in one or more third user information fields for the second AP. In some examples, the transmission procedure component 1350 is configurable or configured to where the performance of the CoBF transmission procedure be based on the CoBF trigger message.

In some examples, each third user information field of the one or more third user information fields is capable of carrying user information associated with a single STA of the one or more STAs associated with the first AP and common user information for CoBF operations; or. In some examples, each third user information field of the one or more third user information fields is capable of carrying user information associated with multiple STAs of the one or more STAs associated with the first AP and the common user information for CoBF operations.

In some examples, the one or more third user information fields indicate a common spatial configuration for the one or more STAs associated with the first AP.

In some examples, the sounding procedure component 1335 is configurable or configured to transmit, to the one or more STAs associated with the first AP and based on the CoBF sounding response message, a sounding initial control frame (ICF). In some examples, the sounding procedure component 1335 is configurable or configured to receive, from the one or more STAs associated with the first AP and based on the sounding ICF, a sounding initial control response (ICR), where the performance of the CoBF sounding procedure is further based on the sounding ICR.

In some examples, the transmission procedure component 1350 is configurable or configured to transmit, to the one or more STAs associated with the first AP and based on the CoBF transmission response message, a transmission initial control frame (ICF). In some examples, the transmission procedure component 1350 is configurable or configured to receive, from the one or more STAs and based on the transmission ICF, a transmission initial control response (ICR), where the performance of the CoBF transmission procedure is further based on the transmission ICR.

In some examples, to support transmission ICF, the transmission procedure component 1350 is configurable or configured to a timeout field that indicate whether an extended timeout period is to be enforced, the timeout field included in a separate user information field, in a common information field, or in a special user information field. In some examples, to support transmission ICF, the transmission procedure component 1350 is configurable or configured to a timeout duration field that indicate a duration of the extended timeout period, the timeout field included in the separate user information field, in the common information field, or in the special user information field.

In some examples, to support CoBF frame formats, the sounding invite component 1325 is configurable or configured to an indication of a feedback type, an indication of a CoBF phase, an indication of a session identifier, an indication of a sound type, an initial control frame (ICF)/initial control response (ICR) presence indicator, an indication of a quantity of spatial streams, a channel state information reception confirmation indication, or any combination thereof.

In some examples, each of the one or more user information fields are identified by an association identifier that indicates control feedback information or are identified by an identifier of the first AP assigned in a CoBF agreement establishment procedure.

In some examples, at least one of the one or more user information fields is capable of carrying user information associated with multiple STAs of the one or more STAs associated with the first AP.

In some examples, to support first per-AID TID information field, the sounding response component 1330 is configurable or configured to an indication of a feedback type, an indication of a CoBF phase, an indication of an invitation response, a rejection code associate with rejection of the CoBF sounding invite message, an indication of a quantity of spatial streams, or any combination thereof.

In some examples, to support CoBF frame formats, the transmission invite component 1340 is configurable or configured to an indication of a feedback type, an indication of a CoBF phase, an initial control frame (ICF)/initial control response (ICR) presence indicator, an amount of padding to be included in the CoBF transmission response message, punctured channel information, GI+LTF Size, a maximum quantity of AP spatial streams, a quantity of stations, a minimum quantity of symbols, a maximum quantity of symbols, or any combination thereof.

In some examples, each of the one or more user information fields are identified by an association identifier of 2008 that indicates control feedback information or identified by an identifier of a second AP assigned by the first AP during a CoBF agreement establishment procedure.

In some examples, at least one of the one or more feedback user information fields is capable of carrying user information associated with multiple STAs of the one or more STAs associated with the first AP.

In some examples, to support second per-AID TID information field, the transmission response component 1345 is configurable or configured to an indication of a feedback type, an indication of a CoBF phase, an indication of an invitation response, a rejection code associate with rejection of the CoBF transmission invite message, an initial control frame (ICF)/initial control response (ICR) presence indicator, an indication of a duration of an ICR/ICR frame exchange, a quantity of symbols, a physical layer version identifier, a location triggering function permission indication, a quantity of stations, or any combination thereof.

In some examples, the CSI component 1360 is configurable or configured to indicate, based on a failure to obtain cross-basic service set (BSS) CoBF channel state information (CSI) in a previous transmission opportunity, a session identifier in the CoBF sounding invite message that differs from a previous session identifier associated with the previous transmission opportunity to indicate the failure to obtain the cross-BSS CoBF CSI.

In some examples, the CSI component 1360 is configurable or configured to receive, in the CoBF transmission response message, an indication of a failure to obtain CoBF channel state information (CSI). In some examples, the CSI component 1360 is configurable or configured to terminate, based on the reception of the indication of the failure to obtain the CoBF CSI, the CoBF transmission procedure. In some examples, the CSI component 1360 is configurable or configured to transmit, based on the termination of the CoBF transmission procedure, a second sounding invite message associated with a second sounding procedure.

In some examples, the CSI component 1360 is configurable or configured to transmit, based on the reception of the CoBF sounding response message, a channel state information (CSI) confirmation poll message that solicits a CSI confirmation message. In some examples, the CSI component 1360 is configurable or configured to receive, based on the CSI confirmation poll message, the CSI confirmation message that indicates whether CSI was successfully obtained.

FIG. 14 shows a flowchart illustrating an example process 1400 performable by or at a first AP that supports coordinated beam forming frame formats. The operations of the process 1400 may be implemented by a first AP or its components as described herein. For example, the process 1400 may be performed by a wireless communication device, such as the wireless communication device 1300 described with reference to FIG. 13, operating as or within a wireless AP. In some examples, the process 1400 may be performed by a wireless AP, such as one of the APs 102 described with reference to FIG. 1.

In some examples, in 1405, the first AP may transmit, in association with a coordinated beamforming (CoBF) sounding procedure, a CoBF sounding invite message that includes one or more first user information fields for a second AP. In some implementations, aspects of the operations of 1405 may be performed by a sounding invite component 1325 as described with reference to FIG. 13.

In some examples, in 1410, the first AP may receive, based on the CoBF sounding invite message, a CoBF sounding response message that includes a first per-association identifier (AID) traffic identifier (TID) information field. In some implementations, aspects of the operations of 1410 may be performed by a sounding response component 1330 as described with reference to FIG. 13.

In some examples, in 1415, the first AP may perform, based on the CoBF sounding invite message and the CoBF sounding response message, the CoBF sounding procedure. In some implementations, aspects of the operations of 1415 may be performed by a sounding procedure component 1335 as described with reference to FIG. 13.

In some examples, in 1420, the first AP may transmit, in association with a CoBF transmission procedure, a CoBF transmission invite message that includes one or more second user information fields for the second AP, the one or more second user information fields including CoBF operation-related information and information for one or more stations (STAs) associated with the first AP. In some implementations, aspects of the operations of 1420 may be performed by a transmission invite component 1340 as described with reference to FIG. 13.

In some examples, in 1425, the first AP may receive, based on the CoBF transmission invite message, a CoBF transmission response message that includes at least a second per-AID TID information field. In some implementations, aspects of the operations of 1425 may be performed by a transmission response component 1345 as described with reference to FIG. 13.

Implementation examples are described in the following numbered clauses:

The following provides an overview of aspects of the present disclosure:

Aspect 1: A method for wireless communications at a first AP, comprising: transmitting, in association with a coordinated beamforming (CoBF) sounding procedure, a CoBF sounding invite message that comprises one or more first user information fields for a second AP; receiving, based at least in part on the CoBF sounding invite message, a CoBF sounding response message that comprises a first per-association identifier (AID) traffic identifier (TID) information field; performing, based at least in part on the CoBF sounding invite message and the CoBF sounding response message, the CoBF sounding procedure; transmitting, in association with a CoBF transmission procedure, a CoBF transmission invite message that comprises one or more second user information fields for the second AP, the one or more second user information fields comprising CoBF operation-related information and information for one or more stations (STAs) associated with the first AP; and receiving, based at least in part on the CoBF transmission invite message, a CoBF transmission response message that comprises at least a second per-AID TID information field.

Aspect 2: The method of aspect 1, further comprising: initiating the CoBF transmission procedure based at least in part on the CoBF transmission response message.

Aspect 3: The method of any of aspects 1 through 2, further comprising: transmitting a CoBF trigger/synchronization message that indicates triggering information for the CoBF transmission procedure, at least a portion of the triggering information indicated in one or more third user information fields for the second AP; and wherein the performance of the CoBF transmission procedure is based at least in part on the CoBF trigger message.

Aspect 4: The method of aspect 3, wherein each third user information field of the one or more third user information fields is capable of carrying user information associated with a single STA of the one or more STAs associated with the first AP and common user information for CoBF operations; or; and each third user information field of the one or more third user information fields is capable of carrying user information associated with multiple STAs of the one or more STAs associated with the first AP and the common user information for CoBF operations.

Aspect 5: The method of any of aspects 3 through 4, wherein the one or more third user information fields indicate a common spatial configuration for the one or more STAs associated with the first AP.

Aspect 6: The method of any of aspects 1 through 5, further comprising: transmitting, to the one or more STAs associated with the first AP and based at least in part on the CoBF sounding response message, a sounding initial control frame (ICF); and receiving, from the one or more STAs associated with the first AP and based at least in part on the sounding ICF, a sounding initial control response (ICR), wherein the performance of the CoBF sounding procedure is further based at least in part on the sounding ICR.

Aspect 7: The method of any of aspects 1 through 6, further comprising: transmitting, to the one or more STAs associated with the first AP and based at least in part on the CoBF transmission response message, a transmission initial control frame (ICF); and receiving, from the one or more STAs and based at least in part on the transmission ICF, a transmission initial control response (ICR), wherein the performance of the CoBF transmission procedure is further based at least in part on the transmission ICR.

Aspect 8: The method of aspect 7, wherein the transmission ICF comprises: a timeout field that indicates whether an extended timeout period is to be enforced, the timeout field included in a separate user information field, in a common information field, or in a special user information field; and a timeout duration field that indicates a duration of the extended timeout period, the timeout field included in the separate user information field, in the common information field, or in the special user information field.

Aspect 9: The method of any of aspects 1 through 8, wherein the CoBF sounding invite message comprises one or more user information fields that comprise: an indication of a feedback type, an indication of a CoBF phase, an indication of a session identifier, an indication of a sounding type, an initial control frame (ICF)/initial control response (ICR) presence indicator, an indication of a quantity of spatial streams, a channel state information reception confirmation indication, or any combination thereof.

Aspect 10: The method of aspect 9, wherein each of the one or more user information fields are identified by an association identifier that indicates control feedback information or are identified by an identifier of the first AP assigned in a CoBF agreement establishment procedure.

Aspect 11: The method of any of aspects 9 through 10, wherein at least one of the one or more user information fields is capable of carrying user information associated with multiple STAs of the one or more STAs associated with the first AP.

Aspect 12: The method of any of aspects 1 through 11, wherein the first per-AID TID information field comprises: an indication of a feedback type, an indication of a CoBF phase, an indication of an invitation response, a rejection code associated with rejection of the CoBF sounding invite message, an indication of a quantity of spatial streams, or any combination thereof.

Aspect 13: The method of any of aspects 1 through 12, wherein the CoBF transmission invite message comprises one or more user information fields that comprise: an indication of a feedback type, an indication of a CoBF phase, an initial control frame (ICF)/initial control response (ICR) presence indicator, an amount of padding to be included in the CoBF transmission response message, punctured channel information, GI+LTF Size, a maximum quantity of AP spatial streams, a quantity of stations, a minimum quantity of symbols, a maximum quantity of symbols, or any combination thereof.

Aspect 14: The method of aspect 13, wherein each of the one or more user information fields are identified by an association identifier of 2008 that indicates control feedback information or identified by an identifier of a second AP assigned by the first AP during a CoBF agreement establishment procedure.

Aspect 15: The method of any of aspects 13 through 14, wherein at least one of the one or more feedback user information fields is capable of carrying user information associated with multiple STAs of the one or more STAs associated with the first AP.

Aspect 16: The method of any of aspects 1 through 15, wherein the second per-AID TID information field comprises: an indication of a feedback type, an indication of a CoBF phase, an indication of an invitation response, a rejection code associated with rejection of the CoBF transmission invite message, an initial control frame (ICF)/initial control response (ICR) presence indicator, an indication of a duration of an ICR/ICR frame exchange, a quantity of symbols, a physical layer version identifier, a location triggering function permission indication, a quantity of stations, or any combination thereof.

Aspect 17: The method of any of aspects 1 through 16, further comprising: indicating, based at least in part on a failure to obtain cross-basic service set (BSS) CoBF CSI in a previous transmission opportunity, a session identifier in the CoBF sounding invite message that differs from a previous session identifier associated with the previous transmission opportunity to indicate the failure to obtain the cross-BSS CoBF CSI.

Aspect 18: The method of any of aspects 1 through 17, further comprising: receiving, in the CoBF transmission response message, an indication of a failure to obtain CoBF CSI; terminating, based at least in part on the reception of the indication of the failure to obtain the CoBF CSI, the CoBF transmission procedure; and transmitting, based at least in part on the termination of the CoBF transmission procedure, a second sounding invite message associated with a second sounding procedure.

Aspect 19: The method of any of aspects 1 through 18, further comprising: transmitting, based at least in part on the reception of the CoBF sounding response message, a CSI confirmation poll message that solicits a CSI confirmation message; and receiving, based at least in part on the CSI confirmation poll message, the CSI confirmation message that indicates whether CSI was successfully obtained.

Aspect 20: A first AP for wireless communications, comprising a processing system that includes processor circuitry and memory circuitry that stores code, the processing system configured to cause the first AP to perform a method of any of aspects 1 through 19.

Aspect 21: A first AP for wireless communications, comprising at least one means for performing a method of any of aspects 1 through 19.

Aspect 22: A non-transitory computer-readable medium storing code for wireless communications, the code comprising instructions executable by one or more processors to perform a method of any of aspects 1 through 19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
one or more memories storing processor-executable code; and
one or more processors coupled with the one or more memories and individually or collectively operable to execute the code to cause the first AP to:
transmit, in association with a coordinated beamforming (CoBF) sounding procedure, a CoBF sounding invite message that comprises one or more first user information fields for a second AP;
receive, based at least in part on the CoBF sounding invite message, a CoBF sounding response message that comprises a first per-association identifier (AID) traffic identifier (TID) information field;
perform, based at least in part on the CoBF sounding invite message and the CoBF sounding response message, the CoBF sounding procedure;
transmit, in association with a CoBF transmission procedure, a CoBF transmission invite message that comprises one or more second user information fields for the second AP, the one or more second user information fields comprising CoBF operation-related information and information for one or more stations (STAs) associated with the first AP; and
receive, based at least in part on the CoBF transmission invite message, a CoBF transmission response message that comprises at least a second per-AID TID information field.

2. The first AP of claim 1, wherein the one or more processors are individually or collectively further operable to execute the code to cause the first AP to:
initiate the CoBF transmission procedure based at least in part on the CoBF transmission response message.

3. The first AP of claim 1, wherein the one or more processors are individually or collectively further operable to execute the code to cause the first AP to:
transmit a CoBF trigger/synchronization message that indicates triggering information for the CoBF transmission procedure, at least a portion of the triggering information indicated in one or more third user information fields for the second AP, wherein the performance of the CoBF transmission procedure is based at least in part on the CoBF trigger message.

4. The first AP of claim 3, wherein:
each third user information field of the one or more third user information fields is capable of carrying user information associated with a single STA of the one or more STAs associated with the first AP and common user information for CoBF operations; or; and
each third user information field of the one or more third user information fields is capable of carrying user information associated with multiple STAs of the one or more STAs associated with the first AP and the common user information for CoBF operations.

5. The first AP of claim 3, wherein the one or more third user information fields indicate a common spatial configuration for the one or more STAs associated with the first AP.

6. The first AP of claim 1, wherein the one or more processors are individually or collectively further operable to execute the code to cause the first AP to:
transmit, to the one or more STAs associated with the first AP and based at least in part on the CoBF sounding response message, a sounding initial control frame (ICF); and
receive, from the one or more STAs associated with the first AP and based at least in part on the sounding ICF, a sounding initial control response (ICR), wherein the performance of the CoBF sounding procedure is further based at least in part on the sounding ICR.

7. The first AP of claim 1, wherein the one or more processors are individually or collectively further operable to execute the code to cause the first AP to:
transmit, to the one or more STAs associated with the first AP and based at least in part on the CoBF transmission response message, a transmission initial control frame (ICF); and
receive, from the one or more STAs and based at least in part on the transmission ICF, a transmission initial control response (ICR), wherein the performance of the CoBF transmission procedure is further based at least in part on the transmission ICR.

8. The first AP of claim 7, wherein the transmission ICF comprises:
a timeout field that indicate whether an extended timeout period is to be enforced, the timeout field included in a separate user information field, in a common information field, or in a special user information field; and
a timeout duration field that indicate a duration of the extended timeout period, the timeout field included in the separate user information field, in the common information field, or in the special user information field.

9. The first AP of claim 1, wherein, the CoBF sounding invite message comprises one or more user information fields that comprise an indication of a feedback type, an indication of a CoBF phase, an indication of a session identifier, an indication of a sound type, an initial control frame (ICF)/initial control response (ICR) presence indicator, an indication of a quantity of spatial streams, a channel state information reception confirmation indication, or any combination thereof.

10. The first AP of claim 9, wherein each of the one or more user information fields are identified by an association identifier that indicates control feedback information or are identified by an identifier of the first AP assigned in a CoBF agreement establishment procedure.

11. The first AP of claim 9, wherein at least one of the one or more user information fields is capable of carrying user information associated with multiple STAs of the one or more STAs associated with the first AP.

12. The first AP of claim 1, wherein the first per-AID TID information field comprises an indication of a feedback type, an indication of a CoBF phase, an indication of an invitation response, a rejection code associate with rejection of the CoBF sounding invite message, an indication of a quantity of spatial streams, or any combination thereof.

13. The first AP of claim 1, wherein the CoBF transmission invite message comprises one or more user information fields that comprise an indication of a feedback type, an indication of a CoBF phase, an initial control frame (ICF)/initial control response (ICR) presence indicator, an amount of padding to be included in the CoBF transmission response message, punctured channel information, GI+LTF Size, a maximum quantity of AP spatial streams, a quantity of stations, a minimum quantity of symbols, a maximum quantity of symbols, or any combination thereof.

14. The first AP of claim 13, wherein each of the one or more user information fields are identified by an association identifier of 2008 that indicates control feedback information or identified by an identifier of a second AP assigned by the first AP during a CoBF agreement establishment procedure.

15. The first AP of claim 13, wherein at least one of the one or more feedback user information fields is capable of carrying user information associated with multiple STAs of the one or more STAs associated with the first AP.

16. The first AP of claim 1, wherein the second per-AID TID information field comprises an indication of a feedback type, an indication of a CoBF phase, an indication of an invitation response, a rejection code associate with rejection of the CoBF transmission invite message, an initial control frame (ICF)/initial control response (ICR) presence indicator, an indication of a duration of an ICR/ICR frame exchange, a quantity of symbols, a physical layer version identifier, a location triggering function permission indication, a quantity of stations, or any combination thereof.

17. The first AP of claim 1, wherein the one or more processors are individually or collectively further operable to execute the code to cause the first AP to:
indicate, based at least in part on a failure to obtain cross-basic service set (BSS) CoBF channel state information (CSI) in a previous transmission opportunity, a session identifier in the CoBF sounding invite message that differs from a previous session identifier associated with the previous transmission opportunity to indicate the failure to obtain the cross-BSS CoBF CSI.

18. The first AP of claim 1, wherein the one or more processors are individually or collectively further operable to execute the code to cause the first AP to:
receive, in the CoBF transmission response message, an indication of a failure to obtain CoBF channel state information (CSI);
terminate, based at least in part on reception of the indication of the failure to obtain the CoBF CSI, the CoBF transmission procedure; and
transmit, based at least in part on the termination of the CoBF transmission procedure, a second sounding invite message associated with a second sounding procedure.

19. A method for wireless communications at a first access point (AP), comprising:
transmitting, in association with a coordinated beamforming (CoBF) sounding procedure, a CoBF sounding invite message that comprises one or more first user information fields for a second AP;
receiving, based at least in part on the CoBF sounding invite message, a CoBF sounding response message that comprises a first per-association identifier (AID) traffic identifier (TID) information field;
performing, based at least in part on the CoBF sounding invite message and the CoBF sounding response message, the CoBF sounding procedure;
transmitting, in association with a CoBF transmission procedure, a CoBF transmission invite message that comprises one or more second user information fields for the second AP, the one or more second user information fields comprising CoBF operation-related information and information for one or more stations (STAs) associated with the first AP; and
receiving, based at least in part on the CoBF transmission invite message, a CoBF transmission response message that comprises at least a second per-AID TID information field.

20. A non-transitory computer-readable medium storing code for wireless communications, the code comprising instructions executable by one or more processors to:
transmit, in association with a coordinated beamforming (CoBF) sounding procedure, a CoBF sounding invite message that comprises one or more first user information fields for a second AP;
receive, based at least in part on the CoBF sounding invite message, a CoBF sounding response message that comprises a first per-association identifier (AID) traffic identifier (TID) information field;
perform, based at least in part on the CoBF sounding invite message and the CoBF sounding response message, the CoBF sounding procedure;
transmit, in association with a CoBF transmission procedure, a CoBF transmission invite message that comprises one or more second user information fields for the second AP, the one or more second user information fields comprising CoBF operation-related information and information for one or more stations (STAs) associated with the first AP; and
receive, based at least in part on the CoBF transmission invite message, a CoBF transmission response message that comprises at least a second per-AID TID information field.
